(19) United States
(12) Patent Application Publication
(10) Pub. No.: US 2006/0274758 A1
(43) Pub. Date: Dec. 7, 2006

(54) Adaptive skills-based routing

(75) Inventors: Jerry P. Busko, Windham, NH (US); Martin Lachapelle Bernier, Bourcherville (CA)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: CIM Ltd., San Francisco, CA (US)

(21) Appl. No.: 11/141,747

(22) Filed: Jun. 1, 2005

(51) Int. Cl. H04L 12/56

(52) U.S. Cl. 370/395.21; 370/412; 370/232

(57) ABSTRACT

A method and system of processing communications within a communication center is described. The exemplary method receives a communication and determines attributes of the communication necessary for processing the communication. The exemplary method determines a service level of a first queue. When the service level is within range, the method routes the communication using a default set of routing rules. When the service levels are out of range, the method modifies the routing rules and routes the communication using the modified set of routing rules. The method also re-routes pending communications in the queues using the modified set of routing rules.

### TECHNICAL FIELD

The present invention relates to a communication center or other communication service processing centers, and more particularly relates to a routing system having adaptive skills-based routing.

### BACKGROUND INFORMATION

Communication centers distribute calls, emails, faxes, chats, video, video mail, and other communications (hereinafter collectively referred to as “communications”) to available agents in accordance with predetermined criteria. Communication centers typically handle communications dealing with a wide variety of subjects/topics. For example, but not limited to, a communication center may handle communications dealing with product and service information inquiries, account balances, debt collection, financial transactions, and sales of products and services. In order to handle the wide range of communication topics, it is often necessary for the agents to have a variety of skills such as, but not limited to, the ability to speak one or more languages, knowledge of specific products or services, as well as training and experience levels. In order to effectively handle and distribute the communications, it is imperative that the communication center optimize the use of the available resources to control costs.

Communications for specific services may be received in an entirely unpredictable manner and rate, thus creating surges in the demand for a given service while another service might be experiencing a slow down in demand. The communication may need to be stored in a queue until an agent with the necessary skills is available to respond to the communication. The communication center system may need to optimize the available resources to compensate for these variations in demand and constantly achieve a desired service level (i.e., the quality of the communication processing) for a variety of service request communications.

### SUMMARY

In one aspect the invention features a method and a system for processing communications within a communication center. The exemplary method receives a communication and determines attributes of the communication necessary for processing the communication. The exemplary method determines a service level of a queue. When the service level is within range, the method routes the communication using a default set of routing rules. When the service levels are out of range, the method modifies the routing rules and routes the communication using the modified set of routing rules. The method also re-routes pending communications in the queues using the modified set of routing rules.

In another aspect of the invention, a method and system transmits a communication by a user to an agent within a communication center. The method transmits the communication to the communication center and at least one communication attribute associated with handling the communication. The method holds while the communication center determines a first service level of a queue and the communication center changes queue parameters based on the first service level. The method may continue to hold while the communication is placed in the queue based on a similarity of at least one communication attribute and the changed queue parameters. The method may continue to hold while the communication center determines a second service level of the queue and the communication center changes the queue parameters based on the second service level. The method may continue to hold while the communication center determines whether to re-route the communication to another queue based on at least one communication attribute and the twice-changed queue parameter. The method connects the communication of the user to the agent.

It is important to note that the present invention is not intended to be limited to a system or method which must satisfy one or more of any stated objects or features of the invention. It is also important to note that the present invention is not limited to the exemplary or primary embodiments described herein. Modifications and substitutions by one of ordinary skill in the art are considered to be within the scope of the present invention, which is not to be limited except by the following claims.

### BRIEF DESCRIPTION OF THE DRAWINGS

These and other features and advantages of the present invention will be better understood by reading the following detailed description, taken together with the drawings wherein:

FIG. 1 is a system diagram of an exemplary communication routing embodiment used to implement the present invention.

FIG. 2 is a flow chart illustrating an exemplary embodiment of a communication routing method according to the present invention.

FIG. 3 is a flow chart illustrating a first exemplary triggering embodiment according to the present invention.

FIG. 4 is a flow chart illustrating a second exemplary triggering embodiment according to the present invention.

The system and method of communication routing allows a communication center to dynamically adjust queue parameters. The system and method allow the communication center to route newly received communications as well as pending communications based on the dynamically adjusted queue parameters. The exemplary embodiments, described herein, illustrate the system and method in applications involving the processing of incoming communications in an exemplary communication center. However, the systems and methods are not limited to use with any particular type of communication center or communication processing application. The invention is applicable to the processing of incoming communications and outgoing communications. The exemplary embodiment may be used in, for example, but not limited to, automatic call distribution (ACD) systems, private branch exchange (PBX) systems, computer telephony systems, telemarketing systems, communication management systems or a combination of these systems. The term “communication” as used herein is intended to include any of the above-noted types of communications as well as portions or combinations of these and other communications.

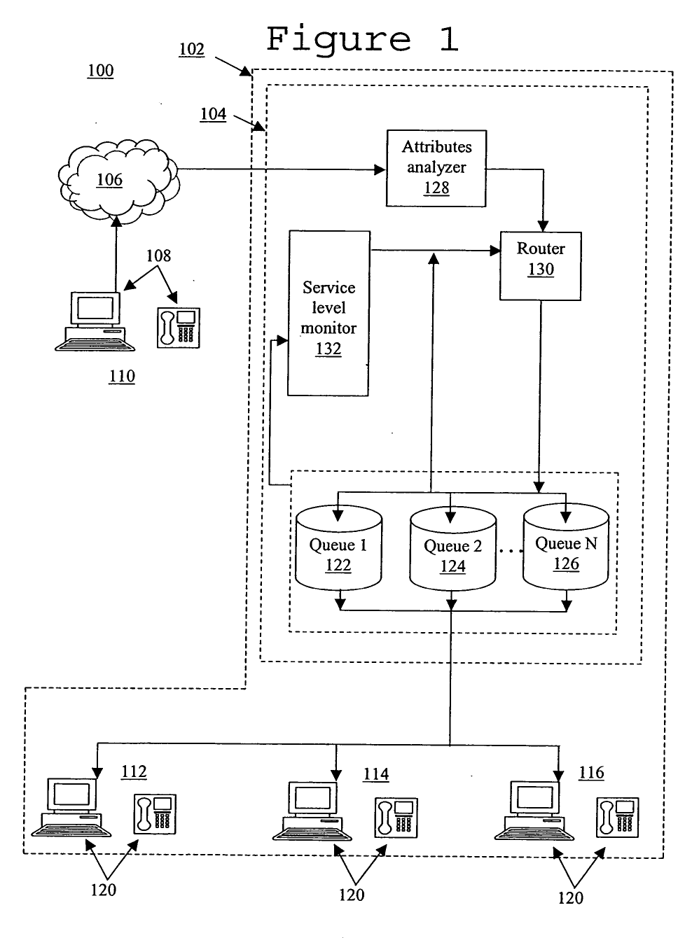

FIG. 1 is an exemplary system diagram used to illustrate the communication routing method and system 100. The communication center 102 has one or more trunk lines that connect an Automatic Call Distributor (ACD) or communication management server 104 to a communication network 106. The communication network 106 provides a communication link to a user communication device 108 of a user 110. The user communication device 108 may be a variety of devices used to send and receive audio and visual communications to the user 110. Examples of the user communication device 108 include but are not limited to a telephone, a videophone, a computer for sending email or text messages, or other communication devices. The user communication device 108 receives information from the user and transmits the information over the communications network 106. The user communication device 108 also may receive information from the communication network 106 and present it to the user in the form of an audible or visual message. The communication network 106 may be a variety of networks of local area networks or wide area networks using a variety of protocols, for example, but not limited to, a Public Switched Telephone Network (PSTN), an Internet Protocol (IP) network using Hypertext Markup Language (HTML) or Internet Protocol Network Telephony (IPNT) or a combination of networks and protocols. The user communication device 108 organizes the information into the format of the desired communication network 106 and transmits the information to the call center 102. For illustrative purpose, the communication network 106 shows only one user 110 transmitting and receiving communications, however, the communication network 106 would have many users and couple to other communication networks (not shown) that may supply additional users.

The communication management server 104 routes communications from the communication network 106 to agents of the communication center. In the exemplary communication network 100, the communication center 102 has three agents (a first agent 112, a second agent 114, and a third agent 116) to handle communications sent and received by the communication center 102. An agent communication device 120 is provided to each agent of the communication center 102. The agent communication device 120 may be a variety of devices used to send and receive audio and visual communications to the user as well as communications with other agents and the contact management server 104. Examples of the agent communication device 120 may include but are not limited to a telephone, a videophone, a computer, or other communication devices. The agents 112, 114, and 116 of the communication center 102 respond to communications placed to the communication center 102 by the user 110. The agents 112, 114, and 116 provide the user 110 with the desired information or the desired action of the user 110.

For example, the user 110 may want to book a Caribbean cruise. The user 110 places a telephone communication to the communication center 102. An automated audio or touch-tone prompting and response system of the communication management server 104 may identify that the user 110 wishes to book a Caribbean cruise. The communication manager server 104 routes the telephone communication to the agent responsible for handling Caribbean cruising bookings. In this example, the second agent 114 may be the agent authorized to book Caribbean cruises. The communication management server 102 routes the call to the second agent 114. The second agent 114 answers the call and books the cruise for the user 110.

From a hardware perspective (not shown), the communication management server 102 may utilize network interfaces, switching fabric, one or more processors, memory, and service circuitry. The one or more trunk lines connect the communication network 106 to the interface of the communication management server 104. The interface of the communication management server 104 also couples to the various agents 112, 114, and 116 servicing the communication center 102. The communication management server 104 receives the communication from the user 110 and routes the communication to an agent 112, 114, and 116. The switching fabric allows the communication management server 104 to selectively switch and distribute the various lines of communication between users 110 and agents 112, 114, and 116. The memory stores the programs and data associated with the routing logic and information necessary to process the communications. The processors execute the stored routines and interfaces with the switching fabric to distribute the communication based on the logic provided by the stored routines. The service circuitry may provide specialized tasks to efficiently use the processor resources of the communication management server 104. For example, the service circuitry may provide audio prompts or collect information associated with routing the communication. The above hardware is an exemplary configuration for illustrative purposes. A variety of other computer, microprocessor, storage devices, and additional hardware components and configurations may be used in combination with the above hardware components.

During peak periods of user 110 communication requests, the call center 102 may have to place a communication of a user 110 on hold in one or more queues 122, 124, and 126 of the communication center 102 until an agent, 112, 114, or 116 is available to respond to the communication request. The communication may be placed in the one or more queues 122, 124, and 126 along with additional communications as additional communications from other users are received by the communication center 102. As agents 112, 114, and 116 become available to respond to communications, the communication is removed from the queue and routed to the available agent. The communication center 102 may have multiple queues, 122, 124, and 126 for various groups of agents. For example, the communication center 102 may have a first queue 122 for sales communications and a second queue 124 for technical support communications.

Agents 112, 114, and 116 may be assigned to specific queues 122, 124, and 126 based upon the skills of the agent and a skill set specified by the queue parameters. Some agents may have skills that match the skill sets of multiple queue parameters. Additionally, an agent may have a skill set that encompasses expertise from lower skill sets. For example, a supervisor may handle communications at the supervisor level and the associate level while an associate may only have the skills required to handle communications at the associate level.

An attributes analyzer 128 of the communication management server 104 may collect communication attributes associated with handling the communication. The communication attributes may include a variety of information associated with the communication. The attributes analyzer 128 may determine information by evaluating the transmitted communication. For example, the attributes analyzer 128 may match the phone number of the user 110 placing the call with previous communications from the same phone number. The attributes analyzer 128 may also use a phone number to determine the geographic location of the user 110 and route the call to the appropriate agent based upon the geographic location of the user 110. The attributes analyzer 128 may provide audio or touch-tone prompts and determine the appropriate agent based upon the user's 110 response. The attributes analyzer 128 is not limited to the above example. The attributes analyzer 128 may use a variety of other techniques for collecting communication attributes.

Based upon the communication attributes, a router 130 of the communication management server 104 matches the communication to the parameters of the queue 122, 124, or 126 to best handle the communication. The queue parameters may be a set of logic routines that provide the skills of the agents servicing the queue 122, 124, or 126. The queue parameters may be stored in memory separate from the queue 122, 124, or 126 or in the same memory associated with the queue 122, 124, or 126. For example, the queue parameter may specify that the agents 112, 114, or 116 assigned to the first queue 122 may handle communications dealing with skill sets A and B. The skill sets of agents assigned to the second queue 124 may have skill sets B and C. The router 130 may route communications requiring skill sets of A, B, or A and B to the first queue 122. For communications requiring skill sets B, C, or B and C, the router 130 may route the communication to the second queue 124.

The communication management server 104 may also include a service level monitor 132 to determine the performance level of the queues 122, 124, and 126. For example, but not limited to, the service level monitor 132 may monitor the average hold times of communications in each queue 122, 124, and 126, the number of communications in a queue, and the rate of increase of communications entering a queue. The service level monitor 132 may also take into account external factors outside of the queues, for example, but not limited to, the time of day or events that may predict or indicate a potential increase or decrease in communications flow or agents available.

The communication management server 104 may use the determined service levels and modify the queue parameters to compensate for inadequate service levels. Based on the previous example, if the service level monitor 132 determines that the hold times of communications in the first queue 122 are exceeding the expected hold times, the communication management server 104 may adjust the first queue parameters to only communications requiring skill set A or sets A and B. The router 130 now routes incoming communications requiring skill set B to the second queue 124. In addition to routing incoming communications, the router 130 may re-examine pending communications within the queues 122, 124, and 126 using the adjusted queue parameters. The pending communications requiring skill set B are sent to the second queue 124. The communication management server 104 can adjust the queue parameters based on the service level of the queues 122, 124, and 126. The communication management server 104 can dynamically adjust the holding location of incoming communications and pending communications.

The communication management server 104 may also use the determined service levels and modify the agents 112, 114, and 116 servicing the queue 122, 124, and 126 along with the queue parameters. Based on the previous example, the service level monitor 132 may determine that there is a large increase in the communications requiring agents with skill set A. The communication management server 104 may pull agents from the second queue 124 that may have a primary skill set of B and a secondary skill set of A. The agents may now service communications requiring skill set A until the surge in communications is under control. This allows the communication management server 104 to pool agents in a dynamic manner.

The communication management server 104 may increase the number of agents servicing a queue or change the skill set of the queue parameters to reduce the incoming or pending communications' hold times and return the queue to proper operating levels as rapidly as possible. Similarly, the number of agents working on a queue may be decreased or the skill set serviced by the queue may be increased to prevent an over-service condition with an agent sitting idle.

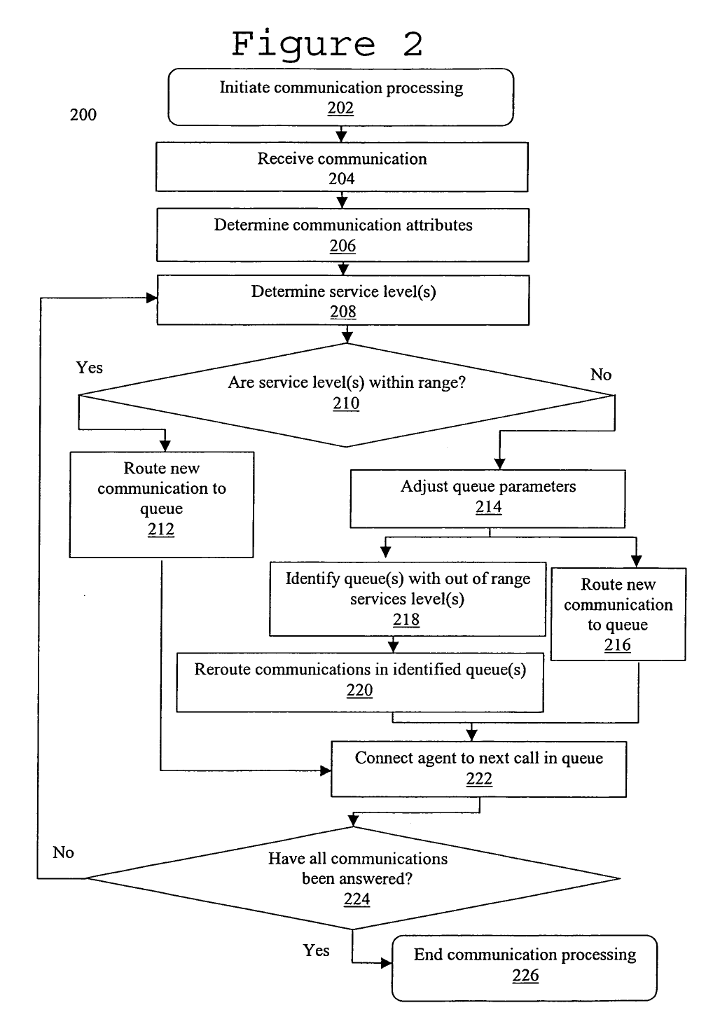

A flow chart illustrating an exemplary communication routing method 200 of the invention is shown in FIG. 2. The exemplary communication routing method 200 allows the communication management server 104 to dynamically adjust queue parameters and agents 112, 114, and 116 servicing the queues 122, 124, and 126. Incoming communications as well as pending communications can be routed to the appropriate queue as the queue parameters are adjusted. The method of the exemplary communication routing method 200 begins when the communication management server 104 (block 202) begins processing communications. The communication center 102 receives the communication (block 204) as previously described. The attributes analyzer 128 receives the communication and determines attributes of the communication for routing the communication to an agent that may service the communication (block 206).

A communication may be analyzed multiple times for routing attributes, not just upon receipt of the communication. For example, after initial analysis an audio prompt and touch-tone response may determine that the user requires an agent with skill set A. An additional audio prompt and touch-tone response triggered by a change in queue parameters may determine that agents with skill set A or skill set B may handle the communication.

The service level monitor 132 determines the service level currently provided by the queues 122, 124, and 126 (block 208). The communication management server 104 determines if the service levels are within predefined ranges (block 210). If the service levels are within predefined ranges (“yes” branch of block 210), the communication is routed to the appropriate queue 122, 124, or 126 based upon a comparison of communication attributes and skill sets of agents servicing the queue (block 212). If the service levels are not within predefined ranges (“no” branch of block 210), the communication management server may adjust the queue parameters (block 214). The communication management server 104 may increase or decrease skills serviced by the queue or adjust the agents servicing the queues 122, 124, and 126. The communication is then routed to the queue based upon the adjusted queue parameters (block 216). The communication management server 104 may also sort through the queues 122, 124, and 126 for pending communications that are no longer in the appropriate queue based on the adjusted queue parameters (block 218). The pending communication may then be rerouted to the appropriate queues 122, 124, and 126 based upon the adjusted queue parameters.

In addition to rerouting the communication to the appropriate queue, additional acts may be taken to maintain the communication's rank in the queue. For example, the communication may be the next to be answered in the first queue 122, however, adjustments to the queue parameter may cause the communication to be sent to the second queue 124. The communication management server 104 may use predefined logic to advance the communication in the second queue 124. Based on the above example, the communication may be advanced in the second queue 124 so that the communication is next to be answered in the second queue 124.

Once an agent is available to service the communication, the communication is connected to the agent (block 222). The communication management server determines if all communications have been answered (block 224). If new communications have arrived or one or more communications still remain in the queues (“no” branch of block 224), the communication management server again determines the service level(s) of the queue(s) (block 208). The method continues to cycle through the process until all communications have been answered. Once all communications have been answered the (“yes” branch of block 224), the communications processing is complete (block 226).

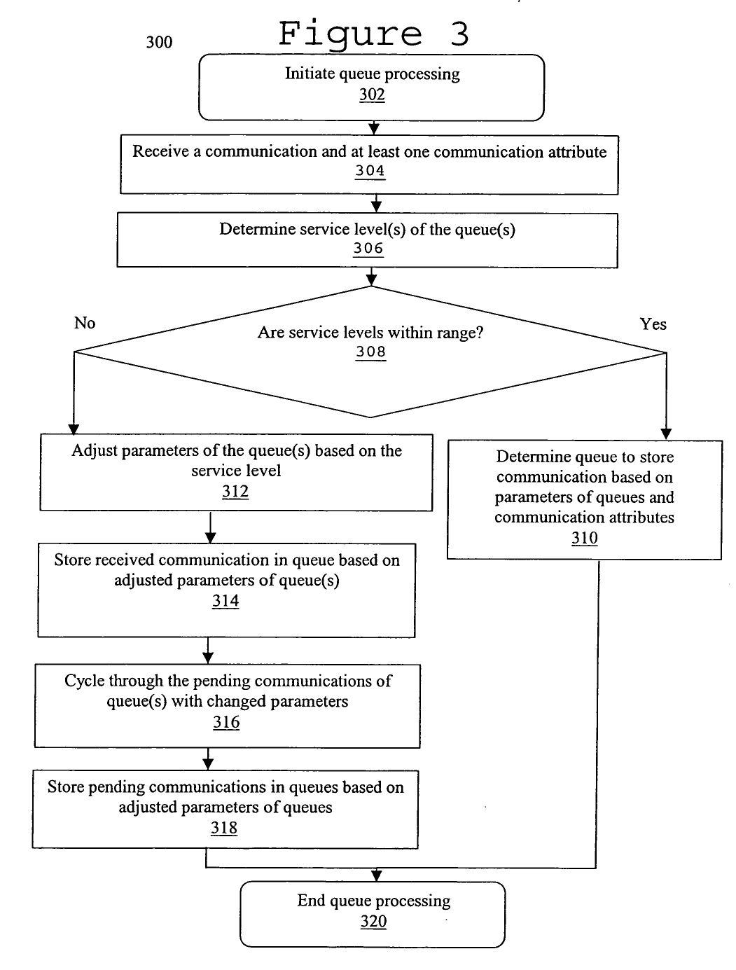

A first exemplary triggering embodiment 300 according to the present invention is illustrated in FIG. 3. The first exemplary triggering embodiment 300 initiates queue processing (block 302) whenever the communication center 102 receives a new communication. The exemplary method receives the communication and at least one communication attribute (block 304). The communication management server 104 determines the service level(s) of the one or more queues 122, 124, 126 (block 308). The method determines whether the service level(s) are within the acceptable range (block 308). If the service level(s) are within an acceptable range (“yes” branch of block 308), the method determines the queue to store the communication based on the current queue parameters and the communication attributes (block 310). If the service level(s) are not within an acceptable range (“no” branch of block 308), the queue parameters are adjusted according to the current out-of-range service level(s) (block 312). The adjustment to the queue parameters may be a predefined adjustment based on various ranges of the service level(s). In another example, the adjustments may include predefined routines that make multiple adjustments to the queue parameter(s). The routines may adjust the queue parameters at predefined intervals that occur after a predefined time or predefined number of communications processed.

The communication management server 104 stores the communications in the queues based on the adjusted queue parameters (block 314). The communication management server 104 cycles through the pending communications currently in the queues 122, 124, and 126 to determine if the pending communications are in the correct queue based on the adjusted queue parameters (block 316). The pending communications that are in the incorrect queue based on the adjusted queue parameters are removed and stored in the queue with the correct queue parameter (block 318). The queue processing is completed until the next communication is received by the communication management system (block 320).

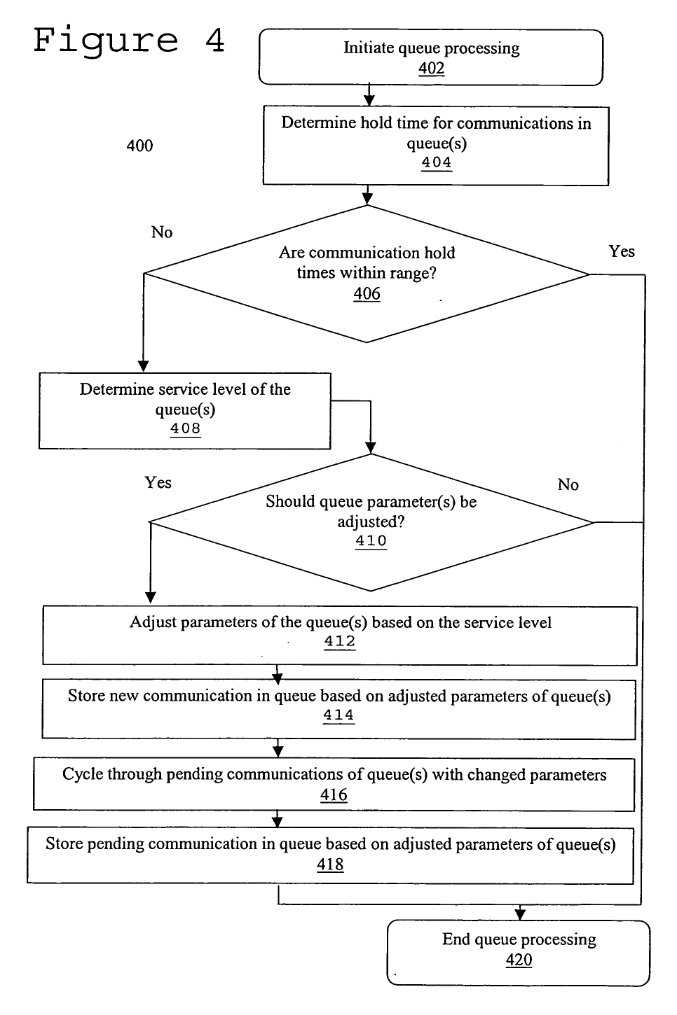

A second exemplary triggering embodiment 400 according to the present invention is illustrated in FIG. 4. The second exemplary triggering embodiment 400 initiates queue processing (block 402). The communication management server 104 determines the hold times of the communications in the one or more queue(s) (block 404). The second exemplary triggering embodiment 400 uses the communication hold time as the service level attribute triggering the queue processing. However, the service level attribute is not limited to the communication hold times. A variety of other attributes may be used to determine satisfactory servicing of communications. The second exemplary triggering embodiment may continuously monitor the communication hold times or monitor the communication hold times on a periodic basis.

The method determines whether the communication hold times are all within the acceptable range (block 406). If the communication hold times are within an acceptable range (“yes” branch of block 406), the queue processing is complete (block 420). If a communication's hold time is not within an acceptable range (“no” branch of block 406), additional service level attributes of the one or more queue(s) 122, 124, and 126 may be determined (block 408).

The communication management server 104 determines if the current out-of-range hold time may be corrected by adjusting the one or more queue parameters (block 410). If adjustments to a queue parameter would not benefit the out-of-range hold time (“no” branch of block 410), the method does not make adjustments to the one or more queue parameters and queue processing is complete (block 420). If the adjustments to a queue parameter will benefit the out-of-range hold time (“yes” branch of block 410), the queue parameter(s) may be adjusted according to the current out-of-range hold time or additional service level attributes (block 412). The adjustment to the queue parameters may be similar to the adjustments as described in the first exemplary triggering embodiment 300.

The communication management server 104 stores the newly received communication in the queues 122, 124, or 126 based on the adjusted queue parameters (block 414). The communication management server 104 may also cycle through the pending communications currently in the queues 122, 124, and 126 to determine if the pending communications are in the correct queue based on the adjusted queue parameters (block 416). The pending communications that are in the incorrect queue based on the adjusted queue parameters are removed and stored in the queue with the correct queue parameter (block 418). The queue processing is completed until the system detects an out of range hold time of a communication being processed (block 420). The method may also include additional acts to prevent a continuous loop. For example, but not limited to, the method may ignore out-of-range hold times for communications that the system has already adjusted queue parameters.

The exemplary embodiments described herein can be implemented in digital electronic circuitry, or in computer hardware, firmware, software, or in combinations of them. The exemplary embodiments described herein can be implemented as a computer program product, i.e., a computer program tangibly embodied in an information carrier, e.g., in a machine-readable storage device or in a propagated signal, for execution by, or to control the operation of, communications processing apparatus, e.g., a processing device, a computer, or multiple computers. A computer program can be written in any form of programming language, including compiled, assembled, or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

The present invention is not intended to be limited to a device or method which must satisfy one or more of any stated or implied object or feature of the invention and is not limited to the exemplary or primary embodiments described herein. Modifications and substitutions by one of ordinary skill in the art are considered to be within the scope of the present invention.

The invention claimed is:

1. A method of processing communications within a communication center comprising the acts of:
receiving a communication;
determining attributes of said communication necessary to process said communication;
determining a service level of at least a first queue, said service level including a first state and at least a second state corresponding to a within range and an out of range serviced state, respectively; and
routing at least said communication based on said service level, wherein said act of routing at least said communication includes:
when said service level corresponds to said first state, routing said communication using a default set of routing rules; and
when said service level corresponds to said second state, said act of routing at least said communication includes:
modifying said default routing rules;
routing said communication using said modified set of routing rules; and
re-routing pending communications in at least said first queue using said modified set of routing rules.

2. The method of processing communications of claim 1 wherein said second state level further includes an over-serviced condition and an under-serviced condition.

3. The method of processing communications of claim 1 wherein said modifying said default routing rules involves substituting a second set of routing rules.

4. The method of processing communications of claim 1 wherein said modifying said default routing rules involves changing a skills set requirement of available agents.

5. The method of processing communications of claim 1 wherein said modifying said default routing rules may be dynamically modified.

6. The method of processing communications of claim 1 wherein determining said service level of at least said first queue and routing at least said communication based on said service level is triggered upon receipt of said communication.

7. The method of processing communications of claim 1 wherein determining said service level of at least said first queue and routing at least said communication based on said service level is triggered by at least one pending communication exceeding a time limit within the first queue.

8. The method of processing communications of claim 1 wherein routing logic governing the method is defined by rules stored within the first queue.

9. A system for processing communications in a communication center, the system comprising:
a module for receiving a communication and at least one communication attribute associated with handling the communication;
a module for determining a first service level of a queue;
a module for changing queue parameters of the queue based on the first service level;
a module for storing the communication in the queue based on a similarity of the at least one communication attribute and the changed queue parameters;
a module for determining a second service level of the queue;
a module for changing the parameters of the queue based on the second service level;
a module for determining whether to re-route the communication to a second queue based on the at least one communication attribute and the twice changed queue parameter; and
a module for connecting the communication of a user to an agent.

10. The system for processing communications of claim 9 wherein said first service level and said second service level each include an over-serviced condition and an under-serviced condition.

11. The system for processing communications of claim 9 wherein the module for changing the parameters of the queue based on the second service level and the module for changing the parameters of the queue based on the second service level substitute the queue parameters with a second set of predefined queue parameters.

12. The system for processing communications of claim 9 wherein the module for changing the parameters of the queue based on the second service level and the module for changing the parameters of the queue based on the second service level changes a skills set requirement of available agents defined by the queue parameter.

13. The system for processing communications of claim 9 wherein the module for determining the first service level is triggered upon receipt of the communication.

14. The system for processing communications of claim 9 wherein the module for determining the second service level is triggered upon receipt of a second communication.

15. The system for processing communications of claim 9 wherein the module for determining the second service level is triggered upon at least one pending communication exceeding a time limit within said queue.

16. The system for processing communications of claim 9 wherein the queue parameters, changed queue parameters, and twice changed queue parameters are stored in the queue.

17. The system for processing communications of claim 9 wherein each module is a set of programmable hardware.

18. A method of transmitting a communication by a user to an agent within a communication center comprising the acts of:
transmitting the communication to the communication center and at least one communication attribute associated with handling the communication;
holding while the communication center determines a first service level of a queue and the communication center changes queue parameters of the queue based on the first service level;
holding while the communication is placed in the queue based on a similarity of the at least one communication attribute and the changed queue parameters;
holding while the communication center determines a second service level of the queue and the communication center changes the queue parameters based on the second service level; and
holding while the communication center determines whether to re-route the communication to another queue based on the at least one communication attribute and the twice changed queue parameter; and
connecting the communication of the user to the agent.

19. The method of transmitting a communication of claim 18 wherein changing queue parameters involves changing a skills set requirement of the available agents defined by the queue parameter.
